(19) United States
(12) Patent Application Publication
(10) Pub. No.: US 2005/0182152 A1
(43) Pub. Date: Aug. 18, 2005

(54) Antimicrobial polymeric coating composition

(76) Inventors: Ralph Nonninger, Saarbruecken (DE); Martin Schichtel, Dudweiler (DE); Christian Goebbert, Riegelsberg (DE)

Correspondence Address: NATH & ASSOCIATES, 1030 15th STREET, NW, 6TH FLOOR, WASHINGTON, DC, 20005, US

(21) Appl. No.: 10/516,930

(22) PCT Filed: Jun. 6, 2003
(86) PCT No.: PCT/EP03/05941

(30) Foreign Application Priority Data
Jun. 6, 2002 (DE) 102 25 324.2

(51) Int. Cl. C08K 3/00

(52) U.S. Cl. 523/122

(57) ABSTRACT

An antimicrobial polymeric coating system comprises core-shell particles, the core comprising nanoscale particles of an inorganic material having a particle size <100 nm and the shell being formed by at least one substance having an antimicrobial action. Of preferred possibility for use are core-shell particles having a titanium dioxide core and a copper or silver shell. This allows permanent protection against bacteria to be provided.

The invention relates to an antimicrobial polymeric coating composition, to a process for preparing it and to the articles coated with it.

Humans are exposed daily to millions of microorganisms such as bacteria, fungi and spores. They are found on virtually every surface, such as on foods, in air-conditioning and ventilation systems or even on toothbrushes. Many of these microorganisms are useful or even necessary. Nevertheless, in addition to the more harmless representatives, there are also bacteria, fungi and spores which cause disease or are even deadly.

Daily dealings with other people and contact with articles which others have used, such as door handles, sanitary installations, lightswitches or faucets, may result in transmission of microorganisms. Particularly in public buildings and especially in hospitals there is increased exposure to this risk. Besides the risks in terms of harm to health, microorganisms (e.g., mold fungi in the sanitary sector) also cause considerable material damage, which amounts annually to a figure of several million euros.

Since humankind was first confronted by this problem, antibacterial substances have been used in order to minimize the risk purged by microorganisms. Thus it was recognized that chemical substances or the use of physical operations critically influence the growth process of bacteria:
physical methods: heat, cold, radiation, ultrasound, etc.
chemical methods: halogens, organic compounds and dyes, toxic gases, metals, etc.

Although in the majority of cases chemical and physical methods are extraordinarily effective in destroying microorganisms, they have only a short-term effect, promote the development of resistance and in some circumstances are unsuitable for certain applications, since they lead to the destruction of the surfaces to be protected. The greatest disadvantage, however, specifically in the case of organic chemical substances, is the hazard or toxicity for human cells. Certain substances, such as formaldehyde, which was employed for many years as a disinfectant, are now suspected of causing cancer or of being extremely harmful from an environmental standpoint.

The stated disadvantages, such as hazard to humans, development of resistance and instability toward chemical influences, are not exhibited by certain heavy metal ions, such as silver or copper and their organic compounds. These compounds are known for their damaging effect on microorganisms (e.g., silver tableware) but have no toxicity for the human body.

Even an organic coating material, such as a water-based acrylic paint, or any organic coating materials known to the skilled worker, can be rendered antimicrobial by the addition of silver compounds. Since, however, the silver salts are washed out of the coating material again very rapidly under ambient conditions, the problem arises that these coating systems only exhibit a very short-term effect.

Accordingly it is an object of the invention to provide a coating system which avoids the depicted disadvantages or reduces them considerably. The aim in particular is to provide a coating system which provides a long-lasting and hence quasipermanent protection against bacteria. The coating system ought to be able to be prepared and applied in a comparably simple way.

This object is achieved by means of the coating composition having the features of claim 1 and by the process having the features of claim 15. Preferred embodiments of this composition and of this process are set out in the dependent claims 2 to 14 and 16 to 19, respectively. Claim 20 defines an article coated with the composition of the invention. Claims 21 to 26 show preferred applications of the composition of the invention. The wording of all of the claims is hereby incorporated by reference into this description.

The antimicrobial polymeric coating composition of the invention is preferably an antimicrobial coating material. The composition comprises, in accordance with the invention, core-shell particles having a core and at least one shell. The core comprises nanoscale particles of an inorganic material having a particle size <100 nm, and the shell is formed by at least one substance having an antimicrobial action. The substance having an antimicrobial action is in particular a metal having an antimicrobial action or having so-called oligodynamic action.

At this point it should be emphasized that the size of the core particles, at <100 nm, is of great importance for the effects which occur in accordance with the invention. The core particles used in accordance with the invention are not simply situated in the sub-μm range, i.e., either just below 1 μm or in the region of a few 100 nm, but are definitively located in the narrow nanoscale range, as defined by the indication <100 nm.

The inorganic materials which can be used as core particles are elucidated further later on in the description. Even at this point, however, attention should be drawn to the fact that particularly suitable core particles are nanoscale particles of inorganic materials having semi-conductor properties. Semiconductor materials of this kind with band gaps preferably between 2 eV and 5 eV are able, as a result of UV excitation, to form electron-hole pairs. The electrons formed migrate to the surface of the core particles and reduce the substances located there, particularly the metal ions located there. As a result of this process a metal film or a metal layer, for example, is deposited on the surface of the core particles. Preferred semiconductor materials having such band gaps are titanium dioxide and cerium oxide. The properties outlined are also of importance for the mode of action of the composition of the invention overall, as will be illustrated again later on.

The choice of the inorganic materials used in accordance with the invention is largely free. These materials are, in particular, a nanoscale oxide, sulfide, carbide or nitride powder. Nanoscale oxide powders are preferred. It is possible to use any powders which are normally used for powder sintering. Examples are (with or without hydration) oxides such as ZnO, CeO₂, SnO₂, Al₂O₃, CdO, SiO₂, TiO₂, In₂O₃, ZrO₂, yttrium-stabilized ZrO₂, Al₂O₃, La₂O₃, Fe₂O₃, Fe₃O₄, Cu₂O, Ta₂O₅, Nb₂O₅, V₂O₅, MoO₃, or WO₃, but also phosphates, silicates, zirconates, aluminates and stannates, sulfides such as CdS, ZnS, PbS and Ag₂S, carbides such as WC, CdC₂ or SiC, nitrides such as BN, AlN, Si₃N₄ and Ti₃N₄, corresponding mixed oxides such as metal-tin oxides, e.g., indium-tin oxide (ITO), antimony-tin oxide, fluorine-doped tin oxide and Zn-doped Al₂O₃, fluorescent pigments with Y or Eu compounds, or mixed oxides with perovskite structure such as BaTiO₃, PbTiO₃ and lead zirconium titanate (PZT). Additionally it is also possible to use mixtures of the powder particles indicated.

Where the nanoscale inorganic material is enclosed by an antimicrobial metal shell the core used preferably comprises nanoscale particles comprising an oxide, oxide hydrate, chalkogenide, nitride or carbide of Si, Al, B, Zn, Zr, Cd, Ti, Ce, Sn, In, La, Fe, Cu, Ta, Nb, V, Mo or W, more preferably of Fe, Zr, Al, Zn, W, and Ti. Particular preference is given to using oxides. Preferred nanoscale inorganic particulate solids are aluminum oxide, zirconium oxide, titanium oxide, iron oxide, cerium oxide, indium-tin oxide, silicon carbide, tungsten carbide and silicon nitride.

In principle it is possible to use a very wide variety of substances with an antimicrobial action as shell material for the core-shell particles in the composition of the invention. It is preferred, however, as already stated at the outset, for such substances to comprise metals (or compounds thereof) having a corresponding antimicrobial action—for example, an oligodynamic action. Particular emphasis should be placed here on the metals copper and, in particular, silver, whose corresponding action has already been known for a relatively long time.

In the core-shell particles used in accordance with the invention the nanoscale particles which form the core (inorganic material) preferably possess a particle size of between 5 nm and 50 nm, in particular between 5 nm and 20 nm.

The core-shell particles themselves are preferably likewise nanoscale and possess an (average) particle size of between 5 nm and 100 nm, preferably between 10 nm and 50 nm. Within the last-mentioned range further preference is given to (average) particle sizes of between 20 nm and 45 nm.

Preferred coat thicknesses for the shell are between 0.1 nm and 20 nm, in particular between 1 nm and 10 nm. In the case of the invention it is possible without problems to realize coat thicknesses of between 0.1 nm and 2 nm.

It will be understood that the invention is not restricted to the use of core-shell particles having one core and only one shell coat. Depending on the desired application it is also possible to apply two or more shell coats, preferably in succession, to one core material.

The choice of the polymer material which forms the major constituent of the coating composition of the inventoin is basically a free one in the context of the invention. Accordingly it is possible to use a very wide variety of base materials or binders, especially powder coatings, water-based coatings, two-component systems or silicate paints, for corresponding polymers or coating materials. In this way it is then possible to prepare water-based or solvent-based coating compositions, which are then miscible either with conventional solvents/diluents or with water.

Preference is given in accordance with the invention to coating compositions wherein the polymeric material or coating system is at least partly miscible with water. In this case, therefore, they may be referred to as water-based coating compositions. Particular preference here is given to compositions based on acrylic resin, especially acrylic coating materials of the invention with an antimicrobial action, and to polyurethane-based compositions, especially polyurethane dispersions. It is also possible to use compositions based on a powder coating.

The amount of core-shell particles present in the composition is basically a free choice in the context of the invention. On the one hand, of course, the aim is to provide a particularly good antimicrobial effect and so relatively high amounts will be aimed at in principle. On the other hand, for reasons of cost, the amount of core-shell particles desired in the composition will be as low as possible. Preferred amounts of core-shell particles in the composition are between 0.1% and 15% by weight, in particular between 0.25% and 10% by weight. With particular preference the amounts of core-shell particles in the composition of the invention are between 2% and 4% by weight.

In connection with the corresponding coating composition the invention can also be described such that nanoscale core particles (<100 nm) are utilized as a carrier substance for the antimicrobial shell component. First the surface of the nanoscale core particles (preferably titanium dioxide) is covered with a thin film of the antimicrobial substances (preferably silver). Because of the particle sizes of well below the sub-μm range, and the very large average specific surface area which results, of more than 200 m²/g, a massive amount of antimicrobial substance is immobilized and hence a very large antimicrobial surface is provided. The nanoscale core particles modified to core-shell particles are then distributed homogeneously in an organic polymer system/coating system, such as a commercially customary acrylic paint, by mixing, in particular by way of customary colloid-chemical methods. This ensures a homogeneous distribution of the active antimicrobial substance in the composition/coating material. If, then, in a subsequent step an article or substrate material, which may be composed of any desired material such as plastic, metal, ceramic or glass, is coated with this modified composition—for example, with the modified acrylic/paint—said article/substrate material is distinguished by permanent protection against bacteria.

The permanent protection described is accomplished by virtue of the fact that the nanoparticles coated with the substance (silver) are in statistical and homogeneous distribution on the surface of the applied coat as well, where they act as and when required. If, then, a part of the surface coat is damaged, worn down or rubbed off, for example, as a result of environmental influences, for example, then the part of the coating which is now situated (newly) on the surface possesses exactly the same antimicrobial properties as the part of the coating worn down. This depot effect ensures permanent protection on all kinds of surfaces.

Where an inorganic material having semiconductor properties is used as core particles, especially titanium dioxide material, the advantages depicted are manifested in particular fashion. In the case of the inventively defined particle sizes for the core partidcles of <100 nm or preferably smaller, <30 nm for example, titanium dioxide is photocatalytically active. By way of the redox system which develops as a result, Ag⁺/Ag and TiO₂ e⁻/TiO₂, there is a controlled and long-lasting release of silver ions in the coating system/material. This supports the permanent antimicrobial action, present in any case, of the coating system.

Emphasis should additionally be given, as an advantage according to the invention, to the fact that the coating system can be processed in a very simple way, such as by conventional spraying, spincoating or dipping processes, for example. All this makes it possible to produce new coatings having a continuous long-term effect extending over several years, when customary coating systems with customary support materials have already long lost their antimicrobial action.

The process of the invention for preparing the coating composition of the invention is characterized in that the core-shell particles described, following their preparation, where appropriate after storage, are mixed with a polymer material, in particular with an organic polymer material. In order to ensure homogeneous distribution of the core-shell particles in this polymer material it is preferred to carry out homogenization by conventional methods.

The preparation of the core-shell particles preferably takes place by using the nanoscale core particles with a particle size <100 nm and applying at least one metal as shell to these core-forming particles in solution or in suspension, by means of a radiation-induced redox reaction. This redox reaction is induced preferably by UV radiation. As already explained, the metal will preferably be copper or, in particular, silver.

In the process described, the solvent used for preparing the solution or suspension will preferably be removed again after the shell has been applied. The powder obtained by the removal of the solvent can then be calcined. By calcining here is meant the heating of the pulverulent materials to the point of a certain degree of decomposition, with the water of crystallization present in the materials being at least partly or, preferably, completely removed.

The coating material obtainable by the process of the invention can, as already described, be further processed and used in a variety of ways: for example, by spraying, dipping or spincoating. Depending on the base (binder) used for the composition the finishing, such as the curing, for example, of the coating is accomplished in different ways. Thus it is preferred to carry out curing at temperatures between 50° C. and 200° C., in particular between 80° C. and 150° C. It is also possible to bring about curing by means of UV crosslinking. Depending on the mode of application the resulting thicknesses of the coatings may differ in magnitude, the aim in principle being for coat thicknesses which are as low as possible. Thus it is preferred for the coat thicknesses of the coating ultimately obtained to be between 0.5 μm and 50 μm, in particular between 2 μm and 10 μm.

As mentioned at the outset, the coating composition of the invention can be used for a very wide variety of purposes in connection with which an antimicrobial action is desired. Particular attention will be drawn here to its use in connection with a very wide variety of insulating materials, which are a particular risk of bacterial attack. Mention may be made here in particular of insulating materials such as are employed for the wrapping of pipes and the like. The coating composition of the invention is of advantage in particular in connection with elastomeric insulating materials.

The coating composition of the invention is also of advantage in connection with industrial insulation, such as is used for insulating pipelines, examples being heating pipes, and for insulating valves and ducts. Mention may be made preferably of all thermal and/or accoustic insulations and insulating materials, such as are used for numerous end applications. Finally, mention will also be made here of industrial foams as preferred substrates for coating. These, as is known, are structures made up of gas-filled cells, which are delimited and connected to one another via cell walls. Like the other materials and articles referred to, these foams or foam materials can likewise be provided—in particular by coating—with the antimicrobial polymeric coating composition of the invention.

Further mention may be made of coatings for air-conditioning plants, condensers, refrigerators and other refrigeration units, and also parts thereof. Emphasis should also be given to the use of the coating composition of the invention as paints for marine craft (civil or military) and for wood preservation.

Mention may also be made of the coating of substrates, preferably substrates of metal, plastic or ceramic, in hygiene installations, hospitals and in the food industry. Particular mention should be made here of articles involving frequent contact, which may easily transmit infection pathogens, such as door handles, sanitary fittings, switches and grips. In the case of such coatings the use of a coating composition in the form of powder coatings has proven particularly advantageous.

The features of the invention that are described, and further features of the invention, are apparent from the description which now follows of examples, in connection with the claims. The individual features of the invention may in each case be actualized alone or in combination with one another.

### EXAMPLES

### Example 1

In order to produce core-shell particles which can be used in accordance with the invention, with a titanium dioxide core and a silver shell, the following procedure is adopted. The silver is first adsorbed in the form of ions on the titanium dioxide surface and then reduced by electrons, which are induced by UV radiation. The coat thickness of the silver can be controlled by the concentration of the silver ions in the suspension/solution and by the intensity and duration of the UV treatment.

In this specific example a quantity of 1 g of nanoscale titanium dioxide powder (Titandioxid P 25, Degussa, Germany) is suspended in an aqueous solution acidified with hydrochloric acid (pH=2), with continual stirring. Silver nitrate, as a readily water-soluble silver salt, is added to this suspension, the amount of silver nitrate being chosen as a function of the desired coat thickness of the silver shell coat. Thereafter the suspension is irradiated with a UV lamp (without filter, with a power of between 80 and 120 watts) for 10 minutes with continual stirring. Subsequently the silver-coated titanium dioxide is worked up by centrifugation, washing with water or dialysis via a semipermeable membrane.

With the chosen irradiation time of 10 minutes it is possible, as a function of the concentration of silver ions, to obtain the following coat thicknesses:

| | |
|---|---|
| 0.01 mol of silver ions | coat thickness 0.1 nm |
| 0.12 mol of silver ions | coat thickness 1 nm |
| 0.32 mol of silver ions | coat thickness 2 nm |

As mentioned above it is possible to vary the coat thickness of the silver coat by means of the irradiation period as well. Starting from 1 g of titanium dioxide and a silver ion concentration of 0.12 mol, the duration of UV irradiation then has the following effect:
1 min UV radiation coat thickness about 0.15 nm
5 min UV radiation coat thickness about 0.65 nm
10 min UV radiation coat thickness about 1 nm

The core-shell particles obtained in this way are provided in the form of a thick, aqueous paste with a concentration of 30% by weight.

3 g of this paste are then incorporated by stirring into 100 ml of a commercially available acrylic coating material (clear varnish, Faust) and homogenized. This gives a modified acrylic coating mateial having outstanding microbial properties. This coating material can be applied in any way (by spraying, dipping or spincoating) to any plastic substrate. Before the coating is applied, the surface of the plastic can be activated in customary fashion by application of a primer or by corona treatment.

### Example 2

In exactly the same way as in example 1, core-shell particles with a titanium dioxide core and a copper ion shell are produced. The copper is used in the form of copper chloride solution (VWR International GmbH, Darmstadt).

Here again a 30% by weight aqueous paste is provided, which is incorporated in the same amount as in example 1 by stirring into an equal amount of acrylic coating material and homogenized. Further processing takes place as in example 1, with the same successful outcome.

### Example 3

In exactly the same way as in example 1, core-shell particles with a titanium dioxide core and a copper ion shell are produced. The copper is used in the form of copper chloride solution (VWR International GmbH, Darmstadt).

Then 3 g of this sample are incorporated by stirring into 1000 ml of ethylene glycol and homogenized. This mixture is polymerized with isocyanate to form a polyurethane. The powder coating obtained in this way is applied to any substrate, preferably to metal, plastic or wood.

1. An antimicrobial polymeric coating composition, in particular an antimicrobial coating material, comprising core-shell particles having a core and at least one shell, wherein
the core comprises nanoscale particles of an inorganic material having a particle size <100 nm, and
the shell is formed by at least one substance having an antimicrobial action, in particular by at least one metal having an antimicrobial action:

2. The coating composition of claim 1, characterized in that the inorganic material possesses semiconductor properties.

3. The coating composition of claim 1 or 2, characterized in that the inorganic material is a nanoscale oxide, sulfide, carbide or nitride powder.

4. The coating composition of claim 1, characterized in that the inorganic material is a nanoscale oxide powder.

5. The coating composition of claim 1, characterized in that the inorganic material is titanium dioxide (TiO₂).

6. The coating composition of claim 1, characterized in that the metal is silver or copper.

7. The coating composition of claim 1, characterized in that the nanoscale particles which form the core possess a particle size of between 5 nm and 50 nm, preferably between 5 nm and 20 nm.

8. The coating composition of claim 1, characterized in that the coreshell particles possess a particle size of between 5 nm and 100 nm, preferably between 10 nm and 50 nm, in particular between 20 nm and 45 nm.

9. The coating composition of claim 1, characterized in that the coat thickness of the shell is between 0.1 nm and 20 nm, preferably between 1 nm and 10 nm.

10. The coating composition of claim 1, characterized in that it is a water-miscible coating composition.

11. The coating composition of claim 1, characterized in that it is a coating composition based on acrylic resins or based on polyurethane.

12. The coating composition of claim 1, characterized in that it is a coating composition based on a powder coating material.

13. The coating composition of claim 1, characterized in that the coreshell particles are present in the composition in amounts of between 0.1% and 15% by weight, preferably in amounts of between 0.25% and 10% by weight and with particular preference in amounts between 2% and 4% by weight.

14. The coating composition of claim 1, characterized in that it is present as a coat on a substrate.

15. A process for preparing an antimicrobial polymeric coating composition of claim 1, characterized in that core-shell particles having a core of nanoscale particles of an inorganic material having a particle size <100 nm and a shell of at least one substance having anantimicrobial action are mixed, preferably homogenized, with an organic polymer material.

16. The process of claim 15, characterized in that the core-shell particles are produced using nanoscale particles of an inorganic material having a particle size <100 nm as core, and at least one metal is applied as a shell to these core-forming particles in solution or in suspension, by means of a radiation-induced redox reaction.

17. The process of claim 16, characterized in that the redox reaction is induced by UV radiation.

18. The process of claim 16, characterized in that the metal is copper or silver.

19. The process of claim 16, characterized in that following application of the shell the solvent is removed and preferably the powder thus obtained is calcined.

20. An article characterized in that it is coated at least partly, preferably completely, with the coating composition of claim 1.

21-26. (canceled)
